(19) United States
(12) Patent Application Publication
(10) Pub. No.: US 2010/0277578 A1
(43) Pub. Date: Nov. 4, 2010

(54) INSPECTION CAMERA

(76) Inventor: David MITCHELL, Carina Heights (AU)

Correspondence Address: NIXON & VANDERHYE, PC, 901 NORTH GLEBE ROAD, 11TH FLOOR, ARLINGTON, VA, 22203, US

(21) Appl. No.: 12/433,118

(22) Filed: Apr. 30, 2009

(51) Int. Cl. H04N 7/18

(52) U.S. Cl. 348/61; 348/E07.085

(57) ABSTRACT

An inspection camera (1) for use in concealed spaces that enables the correct orientation of a camera image to be readily determined. The inspection camera (1) comprises a camera assembly (2) having a camera (22), a handle (3) spaced apart from the camera (22), and a bendable shaft (4) comprising coil-wound tempered steel cable (41) having a longitudinal axis and having a handle-mounting ferrule (42) connected to one end of the cable (41) and a camera assembly-mounting ferrule (43) connected to another end of the cable (4). The handle-mounting ferrule (42) and handle (3) are keyed together and the camera assembly-mounting ferrule (43) and camera assembly (2) are keyed together such that the camera (22) is not rotatable relative to the handle (3) about the longitudinal axis so that an orientation of the camera (22) within a confined space can be determined based on how the handle (3) is oriented.

### FIELD OF THE INVENTION

The present invention relates to an inspection camera comprising a handle and camera assembly separated from one another by a bendable shaft. In one aspect of the invention the inspection camera enables the orientation of the camera to be readily determined whilst located within a concealed spaced. In another aspect of the invention, the inspection camera comprises a wireless camera image transmitter for transmitting the camera image to an image display that is not hardwired to the camera.

### BACKGROUND OF THE INVENTION

Inspection cameras for inspecting concealed spaces, such as the cylinders of vehicle engines, are commercially available. A problem with such cameras, however, is that it may be difficult or impossible to determine the orientation of the camera once located within a concealed space. This is because the camera may rotate or twist when moved into the concealed space. Consequently, it may not be possible to determine what part or area of the concealed space is actually being inspected. When inspecting concealed spaces of vehicle engines, for example, camera image orientation is desirable and in some cases critical for correct diagnostic outcomes.

A problem with commercially available inspection cameras having cameras that are hardwired to image viewing monitors is that an operator of such an inspection camera must hold the monitor, leaving only one hand free to manipulate the camera. This can prove to be a difficult task, particularly when working in confined spaces.

### SUMMARY OF THE INVENTION

The present inventor has now developed an inspection camera that overcomes one or more of the problems mentioned above, or provides the public with a useful commercial choice.

According to a first aspect of the present invention, there is provided an inspection camera comprising:
a camera assembly having a camera;
a handle spaced apart from the camera; and
a bendable shaft having a longitudinal axis and connecting the camera assembly to the handle such that the camera is not rotatable relative to the handle about the longitudinal axis and such that an orientation of the camera can be determined based how the handle is oriented.

The camera assembly can be of any suitable size, shape and construction. Any suitable type of camera can be used. Preferably, the camera is miniature, sized to pass through narrow openings or passages to concealed spaces. The camera can comprise an image sensor (such as a charge coupled device) coupled to an image processor of a printed circuit board.

The camera assembly can comprise a housing for containing the camera. The housing can be of unitary construction or comprise two or more connectable pieces. Depending on the type of camera, if necessary, the housing can incorporate a camera lens adjacent the image sensor of the camera.

The camera assembly can comprise a light source for illuminating an area in front of the camera. Any suitable type of light source can be used. Preferably, the light source comprises at least one light emitting diode (LED) mounted to or within the camera housing. Preferably the inspection camera has three LEDs mounted within the camera housing in front of the image sensor.

If desired, the camera housing can be magnetised so as to pick up metallic objects, such as nails and screws. Alternatively, the inspection camera can comprise a magnet that is mountable to the camera housing.

If desired the camera assembly can comprise an inspection mirror mounted or mountable to the camera housing. The mirror can allow for the viewing of images about 90 degrees relative to a lens of the camera.

The handle can be of any suitable size, shape and construction. The handle can comprise a housing. Preferably, the housing is sized and shaped so as to be easily gripped by a hand of a user yet house of one or more other components of the inspection camera. The housing can comprise two or more connectable pieces or halves.

The handle can have an indicator or indicia, such as the word “TOP” on an upper region of the housing, so as to help the user readily determine the orientation of the camera within a concealed space.

The bendable shaft can be of any suitable size, shape and construction, and can be made of any suitable material or materials. Typically, the shaft will substantially retain its bent shape until bent into another configuration by the user. The shaft can be of unitary construction or comprise two or more connectable pieces. The shaft can provide a passage extending along the longitudinal axis and the passage can serve as a conduit for wires of the inspection camera.

In one embodiment, the shaft comprises a coil-wound tempered steel cable that provides a central passage that extends along the longitudinal axis of the shaft. The passage can serve as a conduit for wires of the inspection camera. The shaft can further comprise a protective sleeve, such as a plastic sleeve, extending over the coil-wound steel cable. The shaft is preferably about 0.5-20 m in length, and more preferably about 700 mm in length.

The shaft can be connected to the camera assembly and handle in any suitable way such that the camera is not rotatable relative to the handle about the longitudinal axis of the shaft. For example, the handle, the camera assembly and opposing ends of the shaft can be keyed together.

The shaft can comprise a handle-mounting ferrule connected to one end of the coil-wound steel cable and a camera assembly-mounting ferrule connected to the other end of the coil-wound steel cable. The handle-mounting ferrule can be keyed together with the housing of the handle. The camera assembly-mounting ferrule can be keyed together with the housing of the camera assembly or printed circuit board of the camera.

According to a second aspect of the present invention, there is provided an inspection camera comprising:

a camera assembly having a camera;

a handle spaced apart from the camera; and

a bendable shaft comprising coil-wound tempered steel cable having a longitudinal axis and having a handle-mounting ferrule connected to one end of the cable and a camera assembly-mounting ferrule connected to another end of the cable,

wherein when the handle-mounting ferrule and said handle are keyed together and when the camera assembly-mounting ferrule and said camera assembly are keyed together the camera is not rotatable relative to the handle about the longitudinal axis and an orientation of the camera can be determined based on how the handle is oriented.

The inspection camera can comprise a camera image monitor/display incorporated into the handle. The monitor/display can be of any suitable size, shape and construction. The monitor/display can be hardwired to the camera by way of wires extending through the passage of the coil-wound steel cable.

In another and more preferred embodiment of the invention, the inspection camera can comprise a wireless image transmitter for transmitting camera images to a monitor/display that is not hardwired to the camera. Any suitable type of wireless image transmitter can be used and the transmitter can be located either within the camera assembly or within the handle. Preferably, the transmitter is located within the handle and hardwired to the camera by way of wires extending through the passage of the coil-wound steel cable. The wires can carry imaging data from the camera processor of the printed circuit board to the wireless transmitter, to be received and viewed on a compatible wireless receiver and image display.

The inspection camera can comprise other components such as a power supply (e.g. a rechargeable lithium battery), a power supply on/off switch, a LED lighting brightness control, a battery charging jack, and wireless channel select switches. Typically, these will be incorporated into the handle.

According to a third aspect of the present invention, there is provided an inspection camera comprising:
a camera assembly having a camera;
a handle spaced apart from the camera;
a bendable shaft connecting the camera assembly to the handle; and
a wireless image transmitter for transmitting camera images to an image display that is not hardwired to the camera.

The features of this third aspect can be as described above in respect of the first and second aspects of the invention.

A preferred embodiment of the invention will now be described by way of example with reference to the accompanying figures.

### BRIEF DESCRIPTION OF THE FIGURES

FIG. 1 is a perspective view of an inspection camera, according to an embodiment of the present invention;

FIG. 2 is a partially exploded view of that shown in FIG. 1;

FIG. 3 is a cut away and partially exploded view of part of the inspection camera shown in FIG. 2;

FIG. 4 is a side elevation view of that shown in FIG. 3, showing how a shaft and handle of the inspection camera are keyed together; and

FIG. 5 is an end elevation view of the inspection camera shown in FIG. 1.

### DESCRIPTION OF PREFERRED EMBODIMENT

In the figures, like reference numerals refer to like features.

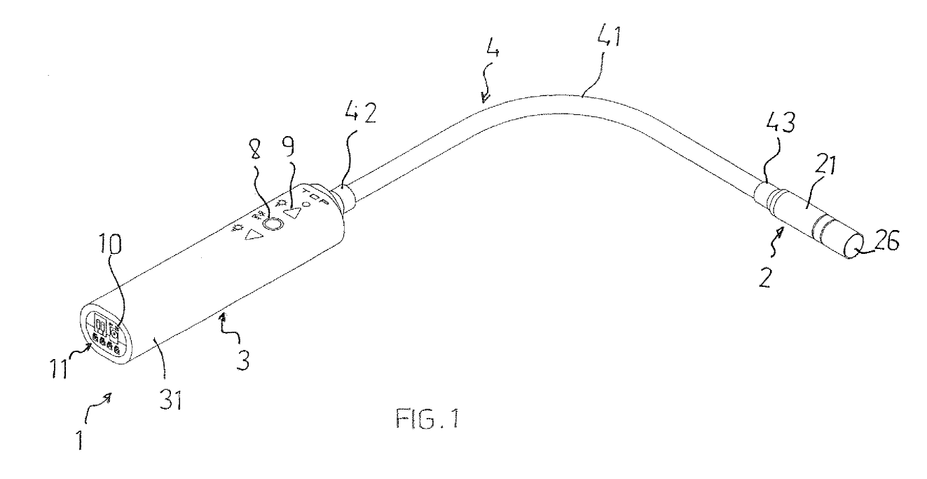

Referring first to FIG. 1, there is shown an inspection camera 1 comprising a camera assembly 2, a handle 3 and a bendable shaft 4 connecting the camera assembly 2 to the handle 3.

The shaft 4 comprises a coil-wound tempered steel cable 41. The cable 41 provides a central passage that extends along a longitudinal axis of the shaft 4, the passage serves as a conduit for wires 61 of the inspection camera 1. The cable 41 enables the shaft 4 to substantially retain its bent shape until bent into another configuration by a user of the inspection camera 1. The shaft 4 is about 700 mm in length.

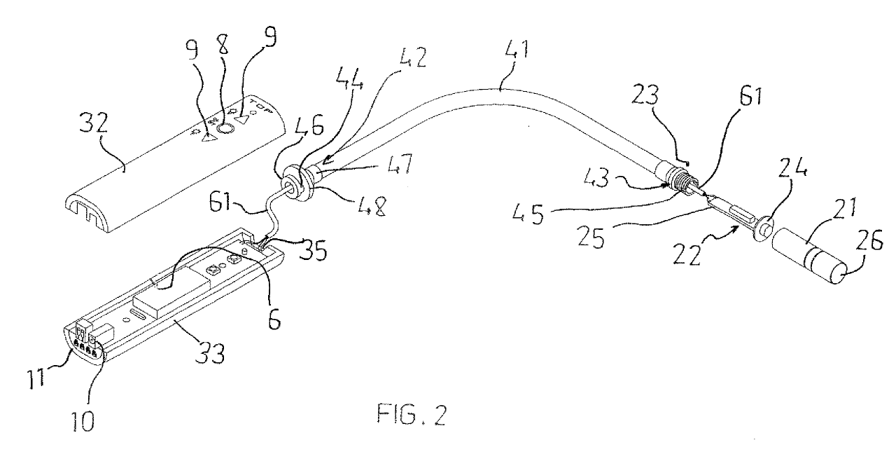

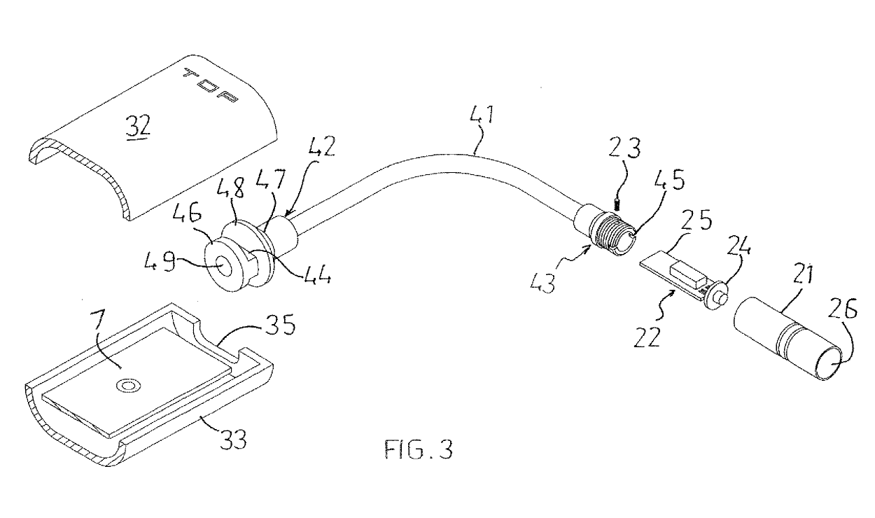

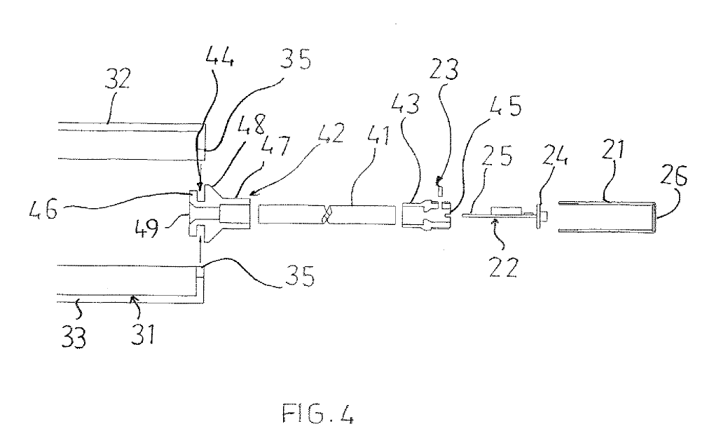

The shaft 4 comprises a handle-mounting ferrule 42 connected to one end of the cable 41 and a camera assembly-mounting ferrule 43 connected to the other end of the cable 41. As seen in FIG. 2, the ferrule 43 has a central passage (not labelled) through which wires 61 of the inspection camera 1 extend, and a transversely extending slot 45 (best viewed in FIG. 3). Ferrule 42 has a discoid head 46, a tail end 47 engaging the cable 41, a flange 48 and a narrow (pinched) neck 44 located between the flange 48 and the head 46. Ferrule 43 also has a central passage 49 through which wires 61 of the inspection camera 1 extend. As seen in FIG. 4, the neck 44 has opposing upper and lower flat surfaces situated each side of the central passage 49.

The camera assembly 2 comprises a camera housing 21, a miniature camera 22 contained within the housing 21, three light emitting diode (not shown) mounted to an interior of the housing 21, and a grub screw 23.

As seen in FIGS. 2-4, the camera 22 comprises an image sensor 24 (charge coupled device—CCD) coupled to a processor of a printed circuit board (PCB) 25.

The camera housing 21 is tubular and incorporates a camera lens 26 that is located adjacent the CCD 24 of the camera 22.

The camera housing 21 is screwed to the camera assembly-mounting ferrule 43 as both the housing 21 and ferrule 43 are threaded. An end of the PCB 25 extends within the slot 45 of the ferrule 43 and is fixed in position with grub screw 23. In this way, the camera 22 and ferrule 43 are keyed together such that the camera 22 cannot rotate relative to the ferrule 43/shaft 4 about the longitudinal axis of the shaft 4.

The handle 3 includes a housing 31 comprising upper and lower connectable halves 32, 33. The housing 31 is sized and shaped so as to be easily gripped by hand, yet allow containment of other components of the inspection camera 1. Each half 32, 33 has a cut out 35, as best viewed in FIGS. 2-4.

During assembly of the inspection camera 1, the neck 44 of the handle-mounting ferrule 42 is placed over the cut out 35 of the lower half 33 of the housing 31 and clamped between the upper and lower halves 32, 33 when brought and connected together. That is, the head 46, neck 44 and flange 48 of the ferrule 42 engage the cut outs 35 in such a way that the housing 31 and ferrule 42 are keyed together and the housing 31 cannot rotate relative to the ferrule 42/shaft 4 about the longitudinal axis of the shaft 4. The ferrule 42, cable 41 and ferrule 43 are assembled by way of a jig which places them in correct orientation relative to each other.

As seen in FIG. 2, the inspection camera 1 comprises a wireless image transmitter 6 on a printed circuit board for transmitting camera 22 images to a wireless receiver of an image display (that is not hardwired to the inspection camera 1).

The wireless transmitter 6 is located within the housing 31 and is hardwired to the camera 22 by way of wires 61 extending through the passages 49 of the ferrules 42, 43 and cable 41. The wires 61 carry imaging data from the processor of the PCB 25 to the wireless transmitter 6.

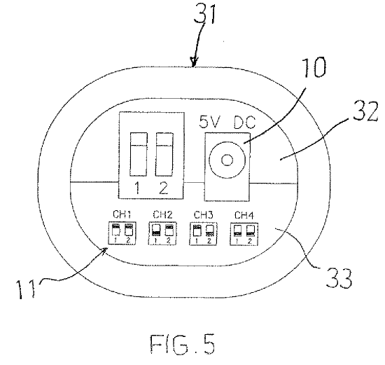

The inspection camera 1 further comprises a rechargeable lithium battery power supply 7 located within the housing 31 (see FIG. 3), a power supply on/off switch 8 located on the upper half 32 of the housing 31 (see FIGS. 1 and 2), a LED lighting brightness control 9 located on the upper half 32 of the housing 31 (see FIGS. 1 and 2), a battery charging jack 10 incorporated into the handle 3 (see FIGS. 2 and 5), and wireless channel select switches 11 also incorporated into the handle 3 (see FIGS. 2 and 5).

In use, the inspection camera 1 is switched on by way of switch 8, the LED intensity is adjusted according to the task at hand by way of control 9, the shaft 4 is bent into an appropriate shape according to the task at hand, and the camera assembly 2 is moved through a narrow opening into a concealed space (such as a cylinder of a vehicle engine).

Since the camera 22 is not rotatable relative to the handle 3, the orientation of the camera 22 within the concealed space can be readily determined with certainty. The word “TOP” is inscribed or printed on the upper half 32 of the housing 31 so as to help the user orientate the camera 22 and camera image, and determine what part or area of the concealed space is actually being inspected.

When inspecting concealed spaces, image orientation is desirable and in some cases critical for correct diagnostic outcomes, such as when inspecting vehicle engines. The present invention provides this advantage. To the inventor's knowledge, there are no commercial inspection cameras that enable the operator to readily determine camera/image orientation when inspecting concealed spaces.

The main disadvantage when using a miniature inspection camera which is hard wired to an image viewing monitor is that the user must hold the monitor, leaving only one hand free to manipulate the camera. This can prove to be a difficult task when working in confined spaces. Using wireless transmission allows the inspection camera and viewing monitor to be stand alone units. The wireless monitor can be placed in a suitable viewing position and both hands are then free to manipulate and manoeuvre the camera into the desired viewing position. Yet another advantage of a wireless inspection camera is that a vehicle technician can be in a vehicle service bay with the inspection camera and the monitor can be taken to the service reception to display a fault to the vehicle owner.

It is to be appreciated that an inspection camera enabling determination of camera orientation within concealed spaces has many different applications, including:
inspection of concealed spaces in buildings for construction defects, electrical wiring or pests (e.g. white ants);
inspection of pipes, ducts and drains;
inspection of vehicle engines and other vehicle parts; and
medical examinations.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

1. An inspection camera comprising:
a camera assembly having a camera;
a handle spaced apart from the camera; and
a bendable shaft having a longitudinal axis and connecting the camera assembly to the handle such that the camera is not rotatable relative to the handle about the longitudinal axis and such that an orientation of the camera can be determined based how the handle is oriented.

2. The inspection camera of claim 1, wherein the handle and a first end of the shaft are keyed together, and a second end of the shaft and the camera assembly are keyed together.

3. The inspection camera of claim 1, wherein the shaft comprises a coil-wound tempered steel cable, a handle-mounting ferrule connected to one end of the cable and a camera assembly-mounting ferrule connected to another end of the cable.

4. The inspection camera of claim 3, wherein the camera comprises an image sensor coupled to a printed circuit board, and the printed circuit board is keyed within a slot in the camera assembly-mounting ferrule.

5. The inspection camera of claim 3, wherein the handle-mounting ferrule is keyed within a cut out region of the handle.

6. The inspection camera of claim 3, wherein the coil-wound tempered steel cable provides a central passage extending along the longitudinal axis of the shaft.

7. The inspection camera of claim 1, wherein the handle has an indicator or indicia so as to help a user understand the orientation of the camera.

8. The inspection camera of claim 1, wherein the inspection camera comprises a wireless image transmitter for transmitting camera images to an image display that is independent of the inspection camera.

9. The inspection camera of claim 8, wherein the wireless image transmitter is located within the handle.

10. An inspection camera comprising:
a camera assembly having a camera;
a handle spaced apart from the camera; and
a bendable shaft comprising coil-wound tempered steel cable having a longitudinal axis and having a handle-mounting ferrule connected to one end of the cable and a camera assembly-mounting ferrule connected to another end of the cable,
wherein when the handle-mounting ferrule and said handle are keyed together and when the camera assembly-mounting ferrule and said camera assembly are keyed together the camera is not rotatable relative to the handle about the longitudinal axis and an orientation of the camera can be determined based on how the handle is oriented.

11. An inspection camera comprising:
a camera assembly having a camera;
a handle spaced apart from the camera;
a bendable shaft connecting the camera assembly to the handle; and
a wireless image transmitter for transmitting camera images to an image display that is independent of the inspection camera.
